(19) United States
(12) Patent Application Publication
(10) Pub. No.: US 2026/0254767 A1
(43) Pub. Date: Aug. 27, 2026

(54) WIRELESS BACKHAUL PHYSICAL LAYER AGGREGATION

(71) Applicant: MaxLinear, Inc., Carlsbad, CA (US)

(72) Inventors: Lior Nevo, Even Yehuda (IL); Oren Bakshe, Kiryat-Ono (IL); Ingo Volkening, Singapore (SG)

(73) Assignee: MaxLinear, Inc., Carlsbad, CA (US)

(21) Appl. No.: 19/548,737

(22) Filed: Feb. 24, 2026

Related U.S. Application Data
(60) Provisional application No. 63/762,583, filed on Feb. 24, 2025.

(51) Int. Cl. H04L 47/43; H04L 47/36

(52) U.S. Cl. CPC H04L 47/43; H04L 47/36

(57) ABSTRACT

A method may include obtaining an Ethernet frame. The method may also include determining a first priority for the Ethernet frame based on a quality-of-service classification. The method may further include segmenting the Ethernet frame into two or more segments. The method may also include adding metadata to the Ethernet frame or the two or more segments. The method may further include determining multiple links for transmitting the Ethernet frame. The method may also include obtaining values for each link of the multiple links. The method may further include computing a maximum allowed latency for each link of the multiple links. The method may also include selecting a first link of the multiple links based on the values for each link and the maximum allowed latency for each link. The method may further include queueing the Ethernet frame or the two or more segments for transmission using the first link.

### CROSS REFERENCE TO RELATED APPLICATIONS

This U.S. patent application claims priority to U.S. Provisional Patent Application No. 63/762,583, titled “WIRELESS BACKHAUL PHYSICAL LAYER AGGREGATION,” and filed on Feb. 24, 2025, the disclosure of which is hereby incorporated by reference in its entirety.

### TECHNICAL FIELD

This disclosure relates to wireless backhaul physical layer aggregation, and more specifically, to an architecture to support wireless backhaul physical layer aggregation.

### BACKGROUND

Unless otherwise indicated herein, the materials described herein are not prior art to the claims in the present application and are not admitted to be prior art by inclusion in this section.

The physical layer aggregator (PLA) function may facilitate higher transmission capacities by aggregating two or more radio links into a single logical link. The aggregated Ethernet bandwidth (BW) capacity may be the sum of the individual link's Ethernet BW capacity. Upon transmission, traffic may be distributed on a frame-by-frame basis between the modem physical layers (PHYs). Traffic may be aggregated back at the receive (Rx) side according to the transmit (Tx) sequence.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

In an example embodiment, a method may include obtaining an Ethernet frame. The method may also include determining a first priority for the Ethernet frame based on a quality-of-service classification. The method may further include segmenting the Ethernet frame into two or more segments in response to a frame size satisfying a maximum transmission unit. The method may also include adding metadata to the Ethernet frame or the two or more segments. The method may further include determining multiple links for transmitting the Ethernet frame. The method may also include obtaining values for each link of the multiple links. The method may further include computing a maximum allowed latency for each link of the multiple links. The method may also include selecting a first link of the multiple links based on the values for each link and the maximum allowed latency for each link. The method may further include queueing the Ethernet frame or the two or more segments for transmission using the first link.

In another embodiment, a system may include a processor and a memory. The memory may be operable to store instructions that, when executed by the processor, may cause the computing system to obtain an Ethernet frame. The computing system may also determine a first priority for the Ethernet frame based on a quality-of-service classification. The computing system may further segment the Ethernet frame into two or more segments in response to a frame size satisfying a maximum transmission unit. The computing system may also add metadata to the Ethernet frame or the two or more segments. The computing system may further determine multiple links for transmitting the Ethernet frame. The computing system may also obtain values for each link of the plurality of links. The computing system may further compute a maximum allowed latency for each link of the multiple links. The computing system may also select a first link of the multiple links based on the values for each link and the maximum allowed latency for each link. The computing system may further queue the Ethernet frame or the two or more segments for transmission using the first link.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for wireless backhaul physical layer aggregation in a transmit direction;

FIG. 2 illustrates an example frame segmentation from a contiguous frame into multiple segments;

FIG. 3 illustrates an example frame format;

FIG. 4 illustrates an example metadata format;

FIG. 5 illustrates a block diagram of an example system for wireless backhaul physical layer aggregation in a receive direction;

FIG. 6 illustrates an example frame assembly from segments into a contiguous frame;

FIG. 7 illustrates a flowchart of an example method for wireless backhaul physical layer aggregation; and

FIG. 8 illustrates an example computing device.

### DETAILED DESCRIPTION

Described herein is a wireless backhaul physical-layer aggregation architecture that presents multiple parallel radio/modem links as one higher-capacity logical Ethernet connection. Incoming Ethernet frames may be QoS-classified, segmented, and/or tagged with compact metadata. A physical-layer aggregation (PLA) scheduler may select an egress link for each frame/segment using real-time link rates, buffer occupancy/outstanding bytes, and computed latency bounds to maximize utilization while limiting out-of-order delay.

Many current wireless backhaul implementations that attempt multi-link aggregation may treat each radio/modem link as an independent pipe or may rely on coarse load-balancing that may not account for per-link rate variation, buffering, and strict latency requirements. Such approaches may lead to inefficient utilization (e.g., underusing high-rate links), excessive queuing delay for high-priority traffic, head-of-line blocking by large frames, and/or receiver-side reordering complexity or loss sensitivity when frames arrive out of order across heterogeneous links.

Aspects of the present disclosure address these and other limitations by implementing MTU-aware segmentation, per-priority sequencing, and/or latency-bounded multi-link scheduling specifically tailored for wireless backhaul links. The disclosed PLA architecture may classify frames by QoS, segment jumbo frames to prevent head-of-line blocking, and may insert metadata (priority, first/last segment flags, and per-priority sequence numbers) so the receiver can deterministically reorder and reassemble traffic across the links. On the transmit side, the link selection may be computed from real-time link rates, buffer limits, and outstanding bytes, while enforcing a calculated maximum allowed latency and filtering irrelevant links to avoid out-of-order delay and slow-link blocking that can otherwise reduce utilization.

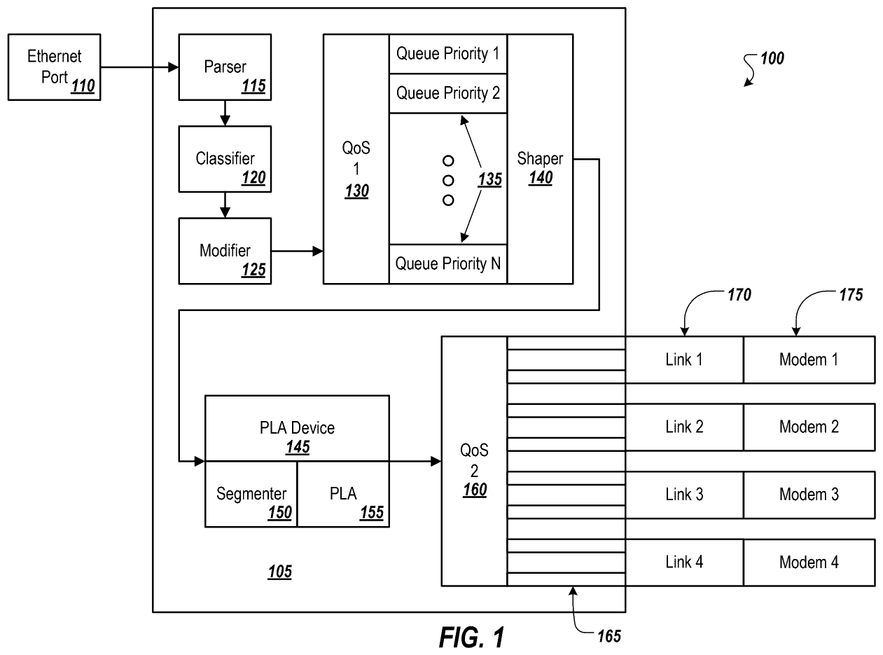

FIG. 1 illustrates a block diagram of an example system 100 for wireless backhaul physical layer aggregation in a transmit direction. In some instances, a URX 105 may be connected to one or more devices, each of which may include multiple links, such as 1 Gbps links for each device. For example, each device may be configured in a 4×1 Gbps, with a one to one mapping between serial gigabit media-independent interface (SGMII) Ethernet (ETH) link and internal modem.

In some instances, Ethernet frames may be received from an Ethernet port 110 (e.g., a 10 Gbps Ethernet port). A parser 115 may parse the Ethernet frames to fetch relevant fields for classification, which may include regular quality of service (QoS) fields, such as Layer 2 Priority Print Code (L2 PCP), Layer 3 Differentiated Services Code Point (L3 DSCP), Multiprotocol Label Switching (MPLS) Experimental Bits (EXP).

In some instances, a classifier 120 may classify the Ethernet frames to one or more predefined sessions, based on the parsed fields. Each session may direct the QoS Stage 1 130 (and/or QoS Stage 2 160) queue priority. There may not be a requirement to do any modification to the frames by a modifier 125. In some instances, the modifier 125 may be operable to add the space for the added metadata (that may be filled with sequence number).

In some instances, the QoS features may be supported, such as at the QoS stage 1 130. In some instances, a customer or other user may define hierarchical QoS and/or any other features described herein. Whatever hierarchical QoS may be defined, the last stage of the hierarchy QoS may have up to eight priority queues 135 and/or a shaper 140. The shaper 140 may be updated in real time with the total capacity sum of all the active radio links 170. Such an arrangement may cause a PLA device 145, which may include a central processing unit (CPU), at the next stage ingress rate to be equal to the egress rate (from the shaper 140) and traffic after the shaper 140 may be prioritized for instances in which the ingress rate is greater than the shaper rate.

The PLA device 145 may be operable to run the PLA algorithm 155, as described herein, and may forward the Ethernet frames to a queue 165 on the way to the relevant modem 175. Each queue 165 may be set with the capacity of the modem 175 connected to it. Such an arrangement can ensure detection of queue congestion. In instances in which the frame size is larger than a predefined threshold (e.g., a default threshold may be 1518B), the PLA device 145 may be operable to segment the Ethernet frame into multiple frames/segments (e.g., to the size of the predefined threshold (1518B), where the last segment may be the remainder), using a segmenter 150.

In some instances, the PLA device 145 (which may be, for example PPv4 egress microcontrollers and/or Atom CPUs) may be in charge of scheduling the Ethernet frames into the different modems 175 based on their capacity, by utilizing the PLA algorithm 155. In some cases, such as in order to reduce latency, it may be beneficial to segment large Ethernet frames into smaller segments. Such actions may be performed prior to the PLA algorithm 155 by the segmenter 150.

In some instances, the PLA device 145 may be operable to support a configuration parameter that may reflect the egress maximum transmission unit (MTU). The egress MTU may be described in bytes units, such as the maximum frame size that may be allowed on the egress Ethernet ports. On a regular Ethernet link, the MTU may be configured to 1500 bytes (thus, including the L2 added fields, such as destination address (DA), source address (SA), EthType (Possible virtual local area networks (VLANs)), and/or cyclic redundancy check (CRC), the frame size may be approximately 1518 bytes long). In such a configuration, it may not be expected that the egress MTU may be set to a lower value, unless the link rates may be low.

In instances in which jumbo Ethernet frames may be used (e.g., up to 10 KB), it may be beneficial to segment large Ethernet frames into smaller segments, so that high priority with low latency Ethernet frames may not need to wait for large Ethernet frames to be fully transmitted before they can be scheduled, thus resulting in high latency. Every Ethernet frame received by the PLA device 145 may be examined to check if it violates the configured egress MTU. In instances in which it does, the Ethernet frame may be segmented into multiple segments, where each segment size may be the egress MTU size, and/or where the last segment size may be the remainder of the original Ethernet frame.

In some instances, packet headers may be pushed to a packet processor pipeline, and packet processor forwarding may be based on ingress port forwarding to a single queue port of QoS Stage 1 130. In such instances, the queue 135 may include the descriptors for each of the PLA groups. The high priority flows may be assigned as QoS Stage 1 130 to a dedicated HP queue. A PLA queue mapper (PQM) may serve the queue with a highest priority over other groups/flows and the descriptors may be forwarded directly to QoS Stage 2 160. In some instances, some descriptors may be assigned to a second queue due to a low latency target on the HP packets.

In these and other instances, the descriptors may be dequeued from the QoS Stage 1 130 by PQM receive and may be based on PLA group flag that may be assigned to the PLA group based on a reorder queue. In some instances, the receive reorder may look at the top of the queues to determine a correct order to send the packets to the egress stage. In some instances, full packets that may be in order, may be sent to an egress queue of the QoS Stage 2 160.

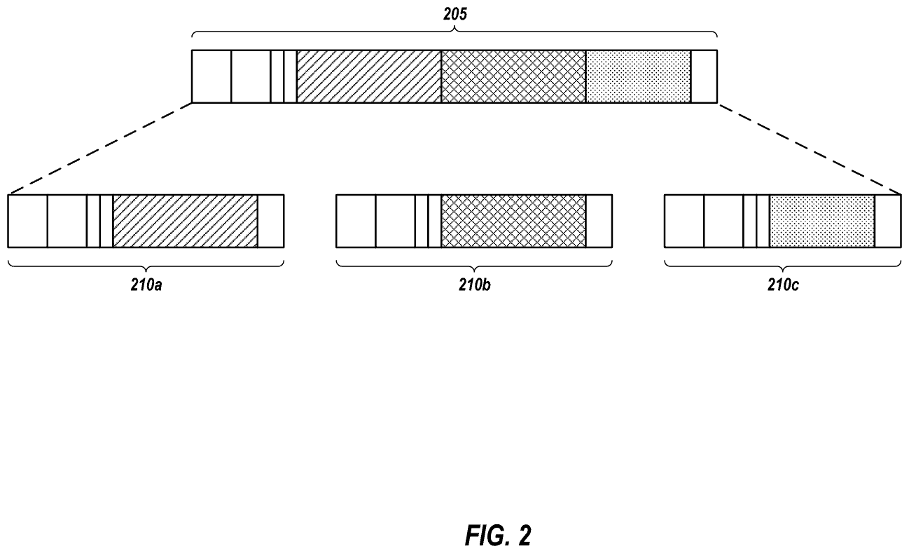

FIG. 2 illustrates an example frame segmentation from a contiguous Ethernet frame 205 into multiple segments 210, including a first segment 210a, a second segment 210b, and a third segment 210c. As illustrated, the contiguous Ethernet frame 205 may be a jumbo Ethernet frame that may be received, where the jumbo Ethernet frame may be 4018 bytes. The egress MTU may be configured to be 1500 bytes and the segmenter 150 may be operable to segment the contiguous Ethernet frame 205. The contiguous Ethernet frame 205 received on the Ethernet port 110 may be 4018 bytes, which may include 18 bytes of L2 fields (DA, SA, EtherType and CRC) and a payload of 4000 bytes. As illustrated, the modifier 125 may add space of two bytes (e.g., between the Ethernet type and the payload) for the metadata. Since the payload may be larger than egress MTU, the PLA device 145 may direct the segmenter 150 to segment the contiguous Ethernet frame 205 into multiple segments, based on the egress MTU size. The first segment 210a and the second segment 210b may have a payload of 1500 bytes, while the third segment 210c may have a payload of 1000 bytes.

On each of the multiple segments 210, the segmenter 150 may provide an indication as to whether the segment may be a first segment, a middle segment (there could be multiple middle segments, depending on total number of segments), and/or a last segment. The multiple segments 210 may be forwarded to the PLA algorithm 155 following processing by the segmenter 150.

In some instances, the PLA algorithm 155 (e.g., in the transmit direction) may utilize a number of pillars. First, the capacity (e.g., the rate) of each of the modems 175 may be known in real time. The capacity may be represented by Rate[1] in Mbps, where 1 may represent the link ID associated with the modem. Second, the buffer size of each of the modems 175 may be known at initialization (where a smaller buffer size may have an effect of the utilization of the links 170). The buffer size may be represented by Buff_Size[1], with bytes as the units. Third, the maximum allowed latency of an Ethernet frame may be a parameter that may be calculated based on the rates and expected latencies of all the modems 175. The maximum allowed latency may be overwritten by a configured target latency, though lower latency restriction can have effect on the total utilization. The maximum latency may be represented as Max_Latency, in nanosecond units.

To perform the calculation for the max allowed latency, the total rate, in Mbps, may be determined (e.g., Total_Rate=SUM(Rate[0 . . . . L−1])), the used capacity, as a percentage, may be determined (e.g., Used_Capacity[1]=Rate[1]/Total_Rate), and the transmit time, in nanoseconds, may be determined (e.g., Tx_Time_MTU[1]=(Egress_MTU+L1_Len)/(Rate[1]/8)*1000). In some instances, the MTU may be 1500 bytes, although for jumbo Ethernet frames, the MTU may be 10000 bytes. Alternatively, or additionally, the L1_Len may include DA/SA/EtherType/Metadata/CRC (e.g., 20 bytes) and/or VLANs (e.g., 4 bytes per VLAN). Finally, the max latency calculation may be performed by Max_Latency=SUM(Used_Capacity[0 . . . . L−1]*Tx_Time_MTU[0 . . . . L−1]). The calculation of max latency may be an average of the time it takes to transmit an MTU frame on each of the modems 175.

When an Ethernet frame may be received, the PLA device 145 may determine which link of the links 170 to which the Ethernet frame may be sent. As the Ethernet frame size and the rate of each of the links 170 may be known, the transmit time, in nanoseconds, of an Ethernet frame on each of the links 170 can be calculated (Tx_Time[1]=Frame_Size/(Rate[1]/8)*1000). In some instances, the Tx_Time[1] and/or [Frame_Size] may be pre-calculated and stored in a lookup table to help performance as part of real time optimization. Alternatively, or additionally, an end transmit time, in nanoseconds and initialized to zero, of the Ethernet frame on each of the links 170 may be calculated, for a current frame and/or a previous frame (End_Time_curr[1]=(End_Time_prev[1]>Curr_Time)?(End_Time_prev[1] +TX_Time[1]):(Curr_Time+TX_Time[1])).

For each of the links 170, a decision may be made whether a particular link may be relevant (Relevant[1]) for transmission, or whether the particular link may be omitted. In some instances, the particular link may be omitted when the link capacity may be low compared to the total capacity of all the links 170. This can be measured in percentage (Min_Capacity_per). The calculation for omitting a link based on link capacity may be represented by: if ((Rate[1]/SUM(Rate[0 . . . . L−1])<Min_Capacity_per), Relevant[1]=FALSE. In instances in which a particular link minimally contributes to the total capacity, the particular link can be omitted without real impact on total utilization of the system 100. For example, in instances in which there are two links where the first link is 1 Gbps and the second link is 1 Mbps. The difference between 1001 Mbps and 1000 Mbps may be neglected (e.g., achieving 1 Gbps is 99.9% of total available utilization). Alternatively, or additionally, such links may not be taken into account for the Max_Latency calculation described herein. Further, this calculation may or may not be performed not in real time.

In some instances, a particular link may be omitted when the outstanding bytes for the particular link may be greater than the buffer size (Out_Bytes[1]). The calculation for omitting a link based on outstanding bytes relative to buffer size may be represented by: if ((Out_Bytes[1]+Frame_Size)>Buff_Size[1]), Relevant[1]=FALSE.

In some instances, a particular link may be omitted when a max allowed latency violation would occur if an Ethernet frame were to be transmitted on the particular link. The calculation for omitting a link based on max allowed latency violation may be represented by: Delta_Time[1]=End_Time_curr[1]−MAX(End_Time_prev[0 . . . . L−1], Curr_Time). A real time optimization may include updating MAX(End_Time_prev[0 . . . . L−1]) for every Ethernet frame. The Delta_Time may indicate an amount of time between an end of new Ethernet frame transmission and the latest transmission time of any other previous Ethernet frame. In some instances, a negative value may indicate a transmission of a particular Ethernet frame would be received prior to another Ethernet frame that was already transmitted. In such instances, an out-of-order may be present, and the particular Ethernet frame may wait for the other Ethernet frame to be received before the particular Ethernet frame can be forwarded. This time must be bound by the Max_Latency: if ((Delta_Time[1]<0 && (−Delta_Time[1]>Max_Latency)), Relevant[1]=FALSE.

Alternatively, or additionally, a positive value may indicate the particular Ethernet frame may finish its transmission after any other previous Ethernet frames that were already scheduled for transmission. In such instances, the earlier finishing of transmission of the particular Ethernet frame may result in other (e.g., faster) links being unavailable for a long duration. For example, in instances in which a fast link is irrelevant due to one of the reasons described herein and a slower link is available, and when a large Ethernet frame is received and transmitted using the slower link, the end time of the transmission using the slower link may be far in the future. When the faster link is available again, it may be unusable, since transmitting a new frame on the faster link would end in the near future, while a scheduled Ethernet frame that is supposed to end in the far future is on the slower link. In such instances, the new Ethernet frame may wait for the already scheduled Ethernet frame end of transmission (to keep the order) and that time may be greater than the Max_Latency allowed.

In order to avoid problem associated with the faster link and the slower link as described, another parameter may be calculated (e.g., on a per link basis) that may define the maximum allowed future end time delta, in nanoseconds: if (Used_Capacity[1]=MAX(Used_Capacity[0 . . . . L−1])), then Max_Future_Time_Delta[1]=Tx_Time_MTU[1] and Max_L=1, else Max_Future_Time_Delta[1]=Used_Capacity[1]/Used_Capacity[Max_L]*Max_Future_Time_Delta[Max_L]. In some instances, such calculation may not be calculated in real time, and may be calculated when Used_Capacity may be calculated. The calculated threshold may be compared to Delta_Time: if (Delta_Time[1]>Max_Future_Time_Delta[1]) Relevant[1]=FALSE.

Determining the earliest end transmit time for all links may be calculated using TX_Link=MIN (End_Time_curr[1]) for each of the links 170 for which Relevant[1] may be TRUE. Prior to making a decision on an individual link to assign the Ethernet frame to (and/or before another Ethernet frame arrives), the End_Time_prev metric may be updated using: End_Time_prev[0 . . . . L−1]=End_Time_curr[0 . . . . L−1].

Alternatively, or additionally, the outstanding bytes (Out_Bytes[1]) may be updated, and/or may be initialized to zero. For a particular link of the links 170, the Ethernet frame size (Frame_Size) may be incremented, which may include adding the header size: Out_Bytes[TX_Link]+=Frame_Size+PLA_Header_Size. For all of the links 170, the time that may have passed relative to a previous decision point may be determined using: Out_Bytes[0 . . . . L−1]−=MAX(Curr_Time-Prev_Time, 0)*Rate[0 . . . . L−1]/8000. Alternatively, or additionally, calculating the outstanding bytes may be performed using: Out_Bytes[0 . . . . L−1]=End_Time_curr[0 . . . . L−1]*Rate[0 . . . . L−1]/8000.

In instances in which no link was determined to be relevant for transmission, a calculation for the availability of each of the links 170 (e.g., when a link may be available for transmission) may be performed. In some instances, consideration as to why a link may be omitted may be made and/or a check for each link may be performed to determine reasons for failure. In instances in which outstanding bytes were not sufficient to accommodate the Ethernet frame, the following two calculations related to insufficient bytes and updates to time may be performed. First, Insufficient_Bytes[1]=Out_Bytes[1]+Frame_Size-Buff_Size[1] and second, Next_Time[1]=Curr_Time+(Insufficient_Bytes*Rate[1]/8000).

In instances in which the reason for failure may have been due to Ethernet frames needing to wait for one another to limit out-of-order Ethernet frames, the time may be updated according to: Next_Time[1]=Curr_Time+MAX(End_Time_curr[0 . . . . L−1])−End_Time_curr[1]−Max_Latency. Alternatively, or additionally, the reason for failure may be due to an Ethernet frame ending too far in the future, which may block other links from use due to the potential of the Ethernet frames being out-of-order (as described herein). In some instances, the Next_Time metric may be selected as the maximum time between the calculations.

TABLE 1

| | | Traffic Pattern | | | | | | | |
|---|---|---|---|---|---|---|---|---|---|
| | | All Big | | | | All Small | | | |
| | Max | Throughput | | Goodput | | Throughput | | Goodput | |
| Rates Dist | Latency | Rate | % | Rate | % | Rate | % | Rate | % |
| All High | 12.1 uSec | 4000 | 100.00% | 3694.74 | 89.87% | 4000 | 100.00% | 3878.79 | 96.97% |
| All Low | 121 uSec | 400 | 100.00% | 389.47 | 89.87% | 400 | 100.00% | 387.58 | 96.97% |
| Low Dist. | 34.7 uSec | 1400 | 100.00% | 1398.18 | 89.87% | 1400 | 100.00% | 1357.58 | 96.97% |
| High Dist. | 22.1 uSec | 2200 | 100.00% | 2197.13 | 89.87% | 2200 | 100.00% | 2133.33 | 96.97% |
| Huge Dist. | 23.1 uSec | 1001.46 | 95.38% | 1000 | 85.25% | 1050 | 100.00% | 1018.18 | 96.97% |

| | | Traffic Pattern | | | | | | | |
|---|---|---|---|---|---|---|---|---|---|
| | | WiKi iMIX | | | | Network iMIX | | | |
| | Max | Throughput | | Goodput | | Throughput | | Goodput | |
| Rates Dist | Latency | Rate | % | Rate | % | Rate | % | Rate | % |
| All High | 12.1 uSec | 4000 | 100.00% | 3978 | 99.45% | 4000 | 100.00% | 3991.29 | 99.78% |
| All Low | 121 uSec | 400 | 100.00% | 387.8 | 99.45% | 400 | 100.00% | 388.33 | 99.78% |
| Low Dist. | 34.7 uSec | 1400 | 100.00% | 1392.3 | 99.45% | 1400 | 100.00% | 1386.85 | 99.78% |
| High Dist. | 22.1 uSec | 2200 | 100.00% | 2187.9 | 99.45% | 2200 | 100.00% | 2195.21 | 99.78% |
| Huge Dist. | 23.1 uSec | 1050 | 100.00% | 1044.23 | 99.45% | 1033.49 | 98.43% | 1031.2 | 98.21% |

Table 1 illustrates example results using the PLA algorithm 155. The rates distribution column is as follows: all high-all links are 1 Gbps; all low-all links are 100 Mbps; low distribution—1×500 Mbps, 1×400 Mbps, 1×300 Mbps, 1×200 Mbps; high distribution-1×1 Gbps, 1×700 Mbps, 1×400 Mbps, 1×100 Mbps; and huge distribution—1×1 Gbps, 1×50 Mbps. Additionally, several traffic patterns are selected, including all big-all frames are 1518 bytes; all small-all frames are 64 bytes; Wiki iMIX—7×64 bytes, 4×594 bytes, 1×1518 bytes; and router-10×1518 bytes, 5×64 bytes, 1×128 bytes, 1×256 bytes, 1×512 bytes, 1×1024 bytes.

Each row in Table 1 represents a different link rate distribution, as described. The Max Latency column illustrates the calculated Max_Latency for each rate distribution use case. The difference between throughput and goodput may be due to the added metadata of 2 bytes per Ethernet frame. For example, the All Big Ethernet frame size may be 1518 bytes and the metadata size may be 2 bytes making the max goodput 99.87%. In another example, the All Small Ethernet frame size may be 64 bytes and the metadata size may be 2 bytes making the max goodput 96.97%. Alternatively, or additionally, segmentation may not be included in the results of Table 1. In some instances, smaller Egress_MTU may result in smaller goodput, as each segment carries at least 20 Bytes of overhead (DA+SA+Type+Metadata+CRC).

In some instances, multiple QoS priorities may be defined. In some instances, Ethernet frames from a higher priority QoS can (and/or may be expected) to be prioritized over Ethernet frames from a lower priority QoS, which may include instances in which the results may be out-of-order. In such instances, for each priority, a near standalone PLA algorithm may be run. Some parameters may remain common, as the links 170 may be a shared resource. In some instances, some parameters may be calculated for each QoS priority. For example, End_Time may be calculated per priority, which could reduce cases of non-relevant links (due to potential out-of-order frames).

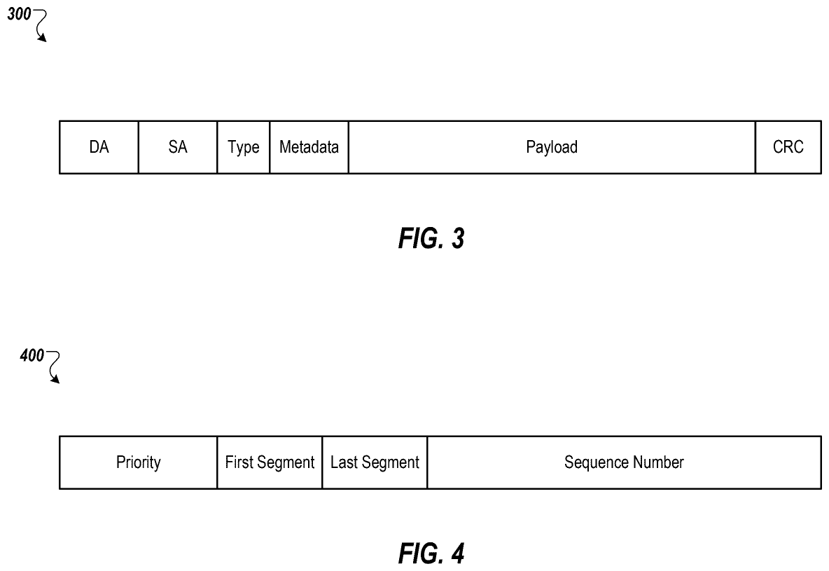

FIG. 3 illustrates an example Ethernet frame format 300, which may include a modifier (e.g., relative to existing frame formats). The modifier may add two bytes between the type (e.g., EtherType) and the payload portions of the Ethernet frame. In instances in which VLAN tags exist, the VLAN tags may be treated by the modifier as part of the payload, such that the added two bytes may be after the first type portion.

FIG. 4 illustrates an example metadata format 400 that may include a priority, a first segment, a last segment, and a sequence number. In some instances, the priority may be three bits and may indicate the priority of the Ethernet frame (based on a classification from the classifier 120). The modifier 125 may be operable to set the priority in the ingress stage. Alternatively, or additionally, as the PLA device 145 may use the priority, the modifier 125 setting the priority in the Ethernet frame may mean that the PLA device 145 may issue a DDR read transaction, which may be undesirable. To reduce DDR transactions, the packet processor may set the priority in the protocol specific portion of the descriptor. Alternatively, or additionally, setting the priority in the Ethernet frame may not be required, as the PLA device 145 may set the other fields of metadata and both may be accomplished in a single transaction.

The first segment and/or the last segment may be one bit each and may be set by the segmenter 150 according to the segment number. For the first segment, the first segment field may be set (e.g., set to one). For the last segment, the last segment field may be set. For any middle segments, both the first segment field and the last segment field may not be set (e.g., may have a value of zero). In instances in which a segmentation is not performed, both the first segment field and the last segment field may be set to indicate no segmentation was performed.

The sequence number may be eleven bits and may be a running sequence number (starting from zero) per priority. When an Ethernet frame may be segmented, each segment may have its own sequence number and/or may be incremented by segment order. In some instances, the number of bits that may be used to represent the priority, the first segment, the last segment, and/or the sequence number may vary based on a desired implementation. For example, less bits may be used for the priority (e.g., in instances in which there may be four priorities) and the extra bit(s) may be used in the sequence number.

As indicated in FIG. 1, the QoS Stage 2 160 may be a second QoS stage where each Ethernet port/modem may be configured with 1-N queues 165, similar to the last stage of QoS Stage 1 130. The PLA device 145 may forward each Ethernet frame to the decided link based on the PLA algorithm 155, and/or the queue within the link may be selected based on the priority. For each link, a capacity indication may be set to the shaper 140. Such an operation may cause traffic to each of the modems 175 to be sent equal to the capacity of each modem, which may result in the modem buffers not completely filling. As such, the high priority Ethernet frames may experience the least latency possible. In some instances, the PLA device 145 can monitor the queues 165 filling level, and based on filling levels, the PLA device 145 can stop the shaper 140, which may result in backpressure and QoS features being applied.

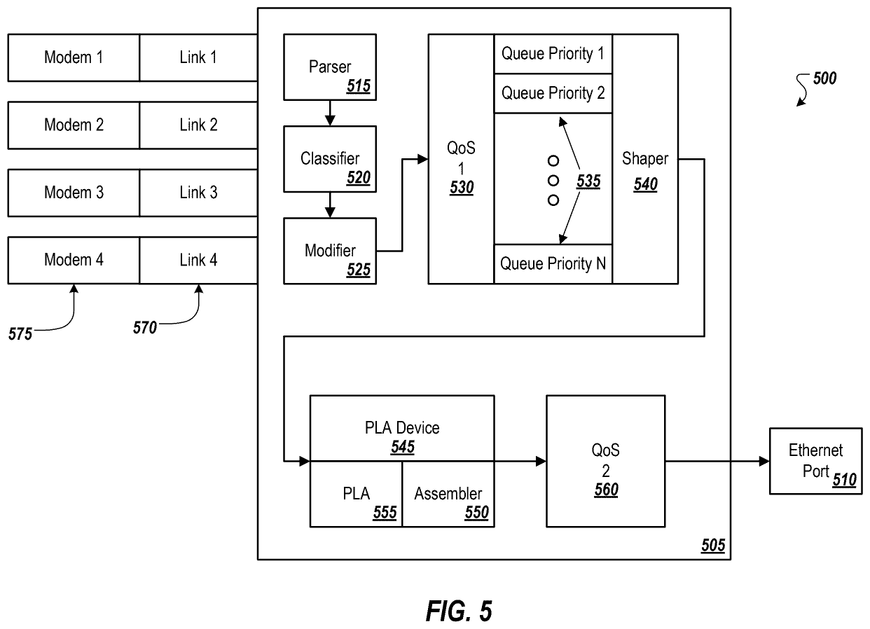

FIG. 5 illustrates a block diagram of an example system 500 for wireless backhaul physical layer aggregation in a receive direction. As illustrated, the components of the system 500 may be the same or similar as the components of the system 100 in the transmit direction as shown in FIG. 1.

One or more frames may be received from modems 575 and/or links 570 (e.g., 1 Gbps ports) and a parser 515 (e.g., PPv4 parser) may or may not parse all of the fields included in the transmit path as the frames may already include the metadata information with the priority set. In instances in which additional QoS granularity is desired, additional parsing and/or classification may be performed.

A classifier 520 may classify the frames to predefined sessions based on the priority associated with the frames. Each session may direct QoS Stage 1 530 (and/or QoS Stage 2 560) queue priority. In some instances, metadata may be removed by a modifier 525 at the modifier stage. In order not to lose the information associated with the metadata, the metadata may be copied to the protocol specific portion of the descriptor. The QoS Stage 1 530 may have a set of priority queues that may be similar to QoS Stage 2 560 (e.g., the QoS Stage 2 160 of FIG. 1) in the transmit path. A PLA device 545 and/or an assembler 550 may be responsible for assembling the segments back to a contiguous frame, and/or may re-order the frames before forwarding them to next stage.

In some instances, the metadata information may include a sequence number per received frame. The PLA device 545 may maintain a cyclic buffer (e.g., for up to 2048 frames corresponding to a sequence number length of the metadata) of descriptors per priority (e.g., if eight priorities are used, then a total of 2048 frames*8 priorities=16384 descriptors). Per priority, the PLA device 545 may maintain the next expected sequence number. If the received frame is equal to the next expected sequence number (and the received frame is not a segmented frame, or all segments of the received frame have been received and assembled), the received frame can be forwarded to the next stage, and next expected sequence number may be incremented.

In some instances, expected frames may not be received (e.g., due to frame drop, CRC errors, etc.). In such circumstances, the next expected sequence number may not be received. The PLA device 545 may maintain a timer per priority. The timer may be restarted every time a frame is forwarded. In instances in which the timer expires, if the next expected frame was not received, the next expected frame may be updated to the closest next in order received frame, and the PLA algorithm 555 may continue as usual from this point, while considering all frames in between as lost. In some instances, the timeout value can be calculated based on known parameters, such as the Total_Rate and/or the Max_Latency, and/or the timeout may be defined in the design stage. In some instances, lost frames can be detected ahead of timeout. For example, if a next expected sequence number is X, and a received frame sequence number is X+Y, it may be determined that the non-received frames between X and X+Y−Z(Z<Y) may be lost.

In some instances, the metadata information may include the first segment and/or the last segment indications, as described herein. If the bits associated with the first segment and the last segment are set (e.g., have a value of 1), the received frame may not have segmented and can be forwarded. Alternatively, the received frame segment may be part of a larger frame that may need to be assembled.

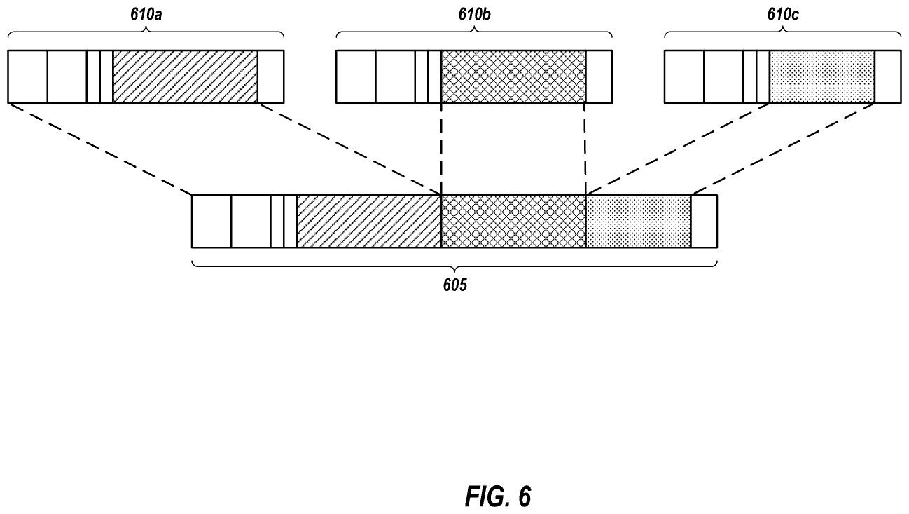

In some instances, segments may be received and/or stored in the cyclic buffers as any other frames. When a next expected sequence number is a first segment segmented frame, the PLA device 545 may confirm that all of the segments associated with the frame have been received, (e.g., all following sequence numbers are middle segments, and the last sequence number is a last segment). In such instances, the assembler 550 may be operable to assemble back all the segments 610 (e.g., a first segment 610a, a second segment 610b, and a third segment 610c) to one contiguous frame 605, as illustrated in FIG. 6. In some instances, the metadata may be received and/or may be removed by the modifier. The PLA CPU may use the protocol specific portion of the descriptor for the metadata information, which may result in the metadata not being present in the frame when the frame may be stored in the cyclic buffers.

On adaptive coding and modulation (ACM) change, the PLA device 545 may receive an indication from the modems 575 relative to a capacity change. In such instances, the PLA device 545 may update the following in order to keep the PLA algorithm 555 and the calculations intact. First, QoS shapers (e.g., the shaper 540) and/or rate limiters may be updated to the new rate. Second, the Rate[1] for the links 570 that may have changed may be updated. Third, the Max_Latency, including assisting parameters Total_Rate and/or Used_Capacity[1] may be updated. Fourth, the Out_Bytes[1] for all links 570 may be updated based on the old rate, using Out_Bytes[0 . . . . L−1]−=MAX(Curr_Time-Prev_Time, 0)*Rate[0 . . . . L−1]/8000. Fifth, the End_Time_prev[1] may be updated based on the new rate, using Out_Bytes[0 . . . . L−1]/(Rate [0 . . . . L−1]/8)*1000 and End_Time_prev[0 . . . . L−1]=Curr_Time+TX_Time[0 . . . . L−1].

In some instances, a radio link outage may be a unique case of ACM change, where one or more link capacities can be considered as zero and may not be available for any additional transmissions. In such instances, the queues 535 associated with the links 570 may not be empty and there could be descriptors waiting for scheduling. In such instances, the descriptors may be diverted to the remaining links. In one example, the queues 535 may be disconnected from the unavailable port and may be reconnected to a different, available port. Alternatively, or additionally, frames may be individually popped from the queues (e.g., of the unavailable port) and may be forwarded to the available links.

In some instances, PPS requirements may be above a CPU limitation. In such instances, the PLA device 545 may not perform a data path calculation and may issue a credit to a PQM hardware module that may direct packets toward a best queue based on the credit calculated by the PLA device 545. For example, for every interval of a quanta, the PLA algorithm 555 may send quanta bytes split into chunks (e.g., 512 byte chunks, which may vary depending on performance). In such instances, the PLA device 545 may restore used credit by either reading from the PQM the used credits and adding more credits to complete the quanta, and/or recalculating a full quanta and overwriting the credits. Such calculation may be less CPU consuming than rerunning a full quanta every interval, but may result in higher latencies as there may be some unused credit that might be used later when it may not be appropriate based on the PLA algorithm 555.

In some instances, various hardware parameters may be used to complete the PLA algorithm in hardware: a link PLA group may be implemented on a per link basis; a link high priority parameter on a per link basis; a credit count on a per link basis that may include a current remaining credit value; a credit usage table implemented as a double buffer and/or an associated credit usage table double buffer index; a credit usage table index; an interval; a credit reset value; a group update flag; and/or a maximum transmission unit value. The credit usage table may include a time window as the row values (which number of rows may be defined in memory), a per link number of bytes transmitted in the time window, a time end value, and/or a double buffer on a per link basis.

A PLA software algorithm may include an initialization including resetting the hardware value parameters. Alternatively, or additionally, the software may define the quanta, calculate (and/or set) the interval (which may be based on the overall rate and the quanta), and may configure the time for a half interval.

For each half interval, the software may read the credit usage table index and may read the rows from last row used from previous half interval to a present row of the credit usage table. Alternatively, or additionally, the software may update the hardware parameters based on the PLA algorithm described above based on the times advanced in the time window table (increment EndTime, OutBytes, and decrement based on elapsed time). For example, the credit usage table may be used as a post mortem for running the PLA algorithm 555. If the time window zero shows X bytes transmitted for a particular link, it may be considered as if X bytes were received at the time that is referenced by time window zero. Then, the same operation may be performed for next time windows until current time is reached.

Next, the software may issue a new credit. The new credit may be added based on the total credit used (e.g., as read from the credit usage table), and/or the software may overwrite the credit with a full quanta. In either option, the software may know the credit to add/overwrite. Based on this quanta, the software may run the PLA algorithm 555 as if a packet byte worth of quanta was received at the current time, as described above (split to chunks). Prior to running PLA algorithm 555, the software may store the parameters (e.g., outstanding bytes, end time, etc. . . . ), and after completing the PLA algorithm 555, the software may restore the parameters to the stored values.

On an ACM event, the software may reset the credit so that the hardware may not forward any additional packets until the software finishes performing calculations. The software may begin by running the first part of the half interval operation based on a configuration before the ACM event. The software may update the link PLA group and/or the link high priority based on the link becoming too low to be used (e.g., the link may be removed), an unused link becoming available (e.g., adding the unused link to the link PLA group), and/or any changing or shifting links to a different group, such as based on a change in priority. The software may also switch the credit usage table double buffer index for the changed links, redefine the quanta, recalculate and set the interval (based on the new overall rate and/or the quanta), and/or reconfigured the software time for the half interval. The software may further run the second part of the half interval operation based on the configuration after the ACM event and set the group updated flag for the group.

A PLA hardware algorithm may include obtaining the PLA group and priority from the descriptor for each packet. In instances in which the priority is high, the hardware may check which links of the PLA group may be defined as high priority and forward the packet accordingly. Alternatively, or additionally, the hardware may determine other links (e.g., regular priority) that may have sufficient credit to transmit the packet bytes, select a link based on a scheduling algorithm and forward the packet to the determined link. Finally, the credit may be reduced for the determined link. The scheduling algorithm may include, but not be limited to strict priority, round robin, strict round robin, maximum available credit, minimum available credit, and/or other various scheduling algorithms. Alternatively, or additionally, in instances in which the packet is forwarded, the credit usage table may be updated for the chosen link.

The PLA hardware algorithm may be operable to reset the credit usage table for each time slot based on incrementing the credit usage table index and performing a comparison to the rows included in the credit usage table. In instances in which a credit reset event occurs, the credit may be reset for each link in the PLA group, the group updated flag may be set (by software), and then some or all of the hardware parameters may be re-read and/or updated. For example, the link PLA group, the link high priority, and the interval may be re-read and the internal hardware parameters may be updated.

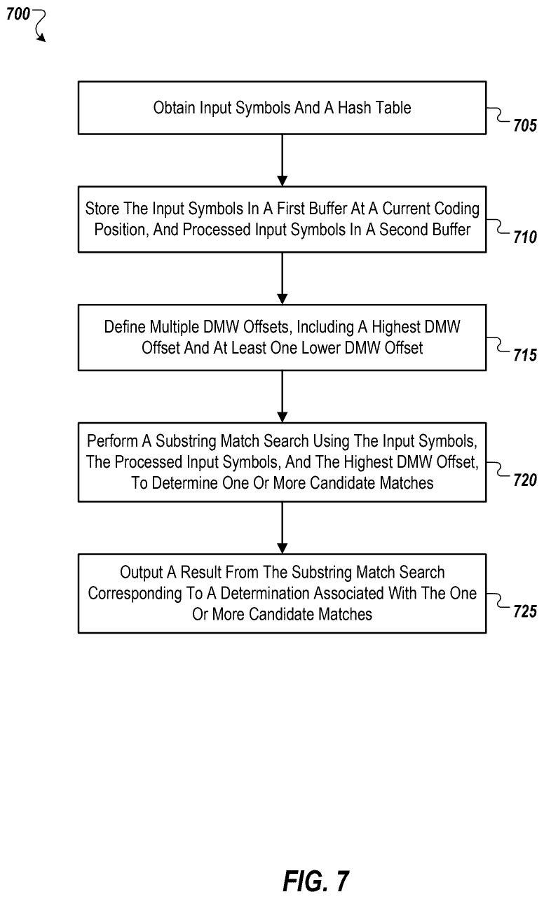

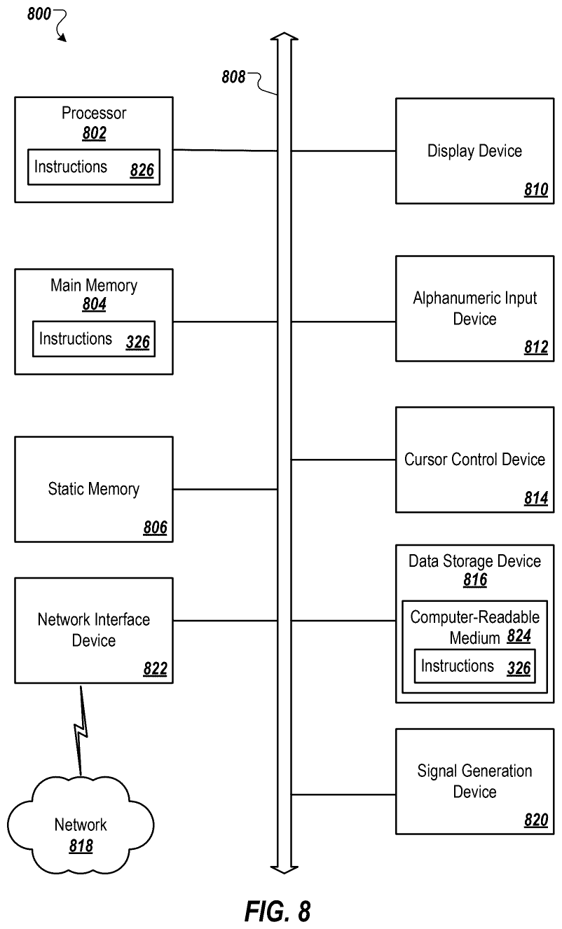

FIG. 7 illustrates a flowchart of an example method 700 for lazy matching with reduced latency for dictionary-based compression. The method 700 may be performed by processing logic that may include hardware (circuitry, dedicated logic, etc.), software (such as is run on a general purpose computer system or a dedicated machine), or a combination of both, which processing logic may be included in any computer system or device such as the URX device 105 of FIG. 1 and/or the computing device 800 of FIG. 8.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 700 may begin at block 705 where processing logic may obtain an Ethernet frame.

At block 710, the processing logic may determine a first priority for the Ethernet frame based on a quality-of-service classification.

At block 715, the processing logic may segment the Ethernet frame into two or more segments in response to a frame size exceeding a maximum transmission unit (MTU). In some instances, at least one of the two or more segments may have a segment size that may be equal to the MTU and a last segment of the two or more segments may have a segment size that may be less than or equal to the MTU. In some instances, segmenting may also include marking each of the two or more segments with an indication corresponding to an order of the two or more segments.

At block 720, the processing logic may add metadata to the Ethernet frame or the two or more segments. In some instances, the metadata may include a priority, a first segment indicator, a last segment indicator, and/or a sequence number. In instances in which the Ethernet frame is segmented, the sequence number corresponding to a segment of the two or more segments is incremented.

At block 725, the processing logic may determine multiple links for transmitting the Ethernet frame.

At block 730, the processing logic may obtain values for each link of the multiple links. In some instances, the values may include a link rate, a link buffer size, and/or outstanding bytes for each link of the plurality of links.

At block 735, the processing logic may compute a maximum allowed latency for each link of the multiple links. In some instances, the maximum allowed latency may be computed using a total rate, a used capacity, and a transmit time associated with each of the multiple links.

At block 740, the processing logic may select a first link of the multiple links based on the values for each link and the maximum allowed latency for each link. In some instances, selecting the first link may include computing, for each link of the multiple links, a transmit time for the Ethernet frame or the two or more segments based on a frame size and a link rate. Alternatively, or additionally, selecting the first link may include computing a predicted end time based on a previous predicted end time and a current time. Alternatively, or additionally, selecting the first link may include selecting the first link based on the transmit time and the predicted end time.

In some instances, selecting the first link may include determining a second link to be irrelevant based on a link capacity associated with the second link relative to a total capacity of the multiple links satisfying a threshold ratio. Alternatively, or additionally, selecting the first link may include determining a second link to be irrelevant when outstanding bytes associated with the second link may be greater than a buffer size associated with the second link. Alternatively, or additionally, selecting the first link may include determining a second link to be irrelevant when adding the Ethernet frame to the second link would exceed the maximum allowed latency for the second link.

At block 745, the processing logic may queue the Ethernet frame or the two or more segments for transmission using the first link.

Modifications, additions, or omissions may be made to the method 700 without departing from the scope of the present disclosure. For example, the processing logic may divert queued Ethernet frames from the second link to one or more links of the plurality of links in response to a second link of the multiple links experiencing an outage.

In another example, the designations of different elements in the manner described is meant to help explain concepts described herein and is not limiting. Further, the method 700 may include any number of other elements or may be implemented within other systems or contexts than those described.

FIG. 8 illustrates an example computing device 800 within which a set of instructions, for causing the machine to perform any one or more of the methods discussed herein, may be executed. The computing device 800 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 800 includes a processing device 802 (e.g., a processor), a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

The processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one implementation, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining an Ethernet frame;
determining a first priority for the Ethernet frame based on a quality-of-service classification;
in response to a frame size exceeding a maximum transmission unit (MTU), segmenting the Ethernet frame into two or more segments;
adding metadata to the Ethernet frame or the two or more segments;
determining a plurality of links for transmitting the Ethernet frame;
obtaining values for each link of the plurality of links;
computing a maximum allowed latency for each link of the plurality of links;
selecting a first link of the plurality of links based on the values for each link and the maximum allowed latency for each link; and
queueing the Ethernet frame or the two or more segments for transmission using the first link.

2. The method of claim 1, wherein at least one of the two or more segments has a segment size equal to the MTU and a last segment of the two or more segments has a segment size less than or equal to the MTU.

3. The method of claim 1, wherein segmenting further comprises marking each of the two or more segments with an indication corresponding to an order of the two or more segments.

4. The method of claim 1, wherein the metadata comprises a priority, a first segment indicator, a last segment indicator, and a sequence number.

5. The method of claim 4, wherein when the Ethernet frame is segmented, the sequence number corresponding to a segment of the two or more segments is incremented.

6. The method of claim 1, wherein the values comprise a link rate, a link buffer size, and outstanding bytes for each link of the plurality of links.

7. The method of claim 6, wherein the maximum allowed latency is computed using a total rate, a used capacity, and a transmit time associated with each of the plurality of links.

8. The method of claim 1, wherein selecting the first link comprises:
computing, for each link of the plurality of links, a transmit time for the Ethernet frame or the two or more segments based on a frame size and a link rate;
computing a predicted end time based on a previous predicted end time and a current time; and
selecting the first link based on the transmit time and the predicted end time.

9. The method of claim 1, wherein selecting the first link comprises determining a second link to be irrelevant based on a link capacity associated with the second link relative to a total capacity of the plurality of links satisfying a threshold ratio.

10. The method of claim 1, wherein selecting the first link comprises determining a second link to be irrelevant when outstanding bytes associated with the second link is greater than a buffer size associated with the second link.

11. The method of claim 1, wherein selecting the first link comprises determining a second link to be irrelevant when adding the Ethernet frame to the second link exceeds the maximum allowed latency for the second link.

12. The method of claim 1, further comprising in response to a second link of the plurality of links experiencing an outage, diverting queued Ethernet frames from the second link to one or more links of the plurality of links.

13. A computing system, comprising:
a processor;
a memory storing instructions that, when executed by the processor, cause the computing system to:
obtain an Ethernet frame;
determine a first priority for the Ethernet frame based on a quality-of-service classification;
in response to a frame size satisfying a maximum transmission unit (MTU), segment the Ethernet frame into two or more segments;
add metadata to the Ethernet frame or the two or more segments;
determine a plurality of links for transmitting the Ethernet frame;
obtain values for each link of the plurality of links;
compute a maximum allowed latency for each link of the plurality of links;
select a first link of the plurality of links based on the values for each link and the maximum allowed latency for each link; and
queue the Ethernet frame or the two or more segments for transmission using the first link.

14. The computing system of claim 13, wherein at least one of the two or more segments has a segment size equal to the MTU and a last segment of the two or more segments has a segment size less than or equal to the MTU.

15. The computing system of claim 13, wherein:
the metadata comprises a priority, a first segment indicator, a last segment indicator, and a sequence number; and
when the Ethernet frame is segmented, the sequence number corresponding to a segment of the two or more segments is incremented.

16. The computing system of claim 13, wherein:
the values comprise a link rate, a link buffer size, and outstanding bytes for each link of the plurality of links; and
the maximum allowed latency is computed using a total rate, a used capacity, and a transmit time associated with each of the plurality of links.

17. The computing system of claim 13, wherein selecting the first link comprises:
compute, for each link of the plurality of links, a transmit time for the Ethernet frame or the two or more segments based on a frame size and a link rate;
compute a predicted end time based on a previous predicted end time and a current time; and
select the first link based on the transmit time and the predicted end time.

18. The computing system of claim 13, wherein selecting the first link comprises determine a second link to be irrelevant based on a link capacity associated with the second link relative to a total capacity of the plurality of links satisfying a threshold ratio.

19. The computing system of claim 13, wherein selecting the first link comprises determine a second link to be irrelevant when outstanding bytes associated with the second link is greater than a buffer size associated with the second link.

20. The computing system of claim 13, wherein the computing system is further operable to divert, in response to a second link of the plurality of links experiencing an outage, queued Ethernet frames from the second link to one or more links of the plurality of links.
